(19) United States
(12) Patent Application Publication
(10) Pub. No.: US 2006/0132827 A1
(43) Pub. Date: Jun. 22, 2006

(54) Methods and systems for providing external processing for a printing device

(75) Inventor: Brent A. Schanding, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/013,620

(22) Filed: Dec. 16, 2004

(51) Int. Cl. G06F 3/12

(52) U.S. Cl. 358/1.15

(57) ABSTRACT

A printing device. The printing device can be configured to communicate with a workstation and an image capturing device, to obtain an image from the image capturing device, to determine if the workstation is available to the printing device, and, when the workstation is available to the printing device, to automatically transmit the image and processing instructions to the workstation, receive a processed image from the workstation, and print the processed image. The printing device can be further configured to process the image to generate a processed image and print the processed image, when the workstation is not connected to the printing device.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND OF THE INVENTION

Embodiments of the invention relate to methods and systems for providing external processing of data transmitted to a printing device. In particular, embodiments of the invention relate to processing data transmitted from an image capturing device to a printing device by a workstation connected to the printing device.

Image capturing devices, such as scanners and digital cameras, allow a user to electronically record images. Traditionally, after a user uses an image capturing device to record an image, the user connects the image capturing device to a workstation. With the image capturing device connected to the workstation, the user can download the recorded image to the workstation and can use the workstation to edit the image, store the image to a memory device, transmit the image over a network such as a local area network (“LAN”) or the Internet, or transmit the image to a printing device, such as a printer, connected to the workstation.

Recently, manufacturers of printing devices and image capturing devices have developed systems and methods for connecting an image capturing device directly to a printing device. By directly connecting an image capturing device to a printing device, a user can process at the printing device an electronic image recorded by the image capturing device without the need for a workstation. In particular, the Camera and Imaging Products Association (“CIPA”) developed the CIPA DC-001 standard, commonly referred to as the PictBridge® standard, that describes a protocol for providing direct communication between image capturing devices and printing devices. The PictBridge® standard enables direct printing of images recorded by a PictBridge-compliant image capturing device connected to a PictBridge®-compliant printing device.

Although a direct connection between an image capturing device and a printing device generally eliminates the need for a workstation, the printing device and/or image capturing device may need to be configured with additional processing capabilities to perform the functions previously provided by a workstation. For example, the printing device may need the capability to rotate an image, crop an image, magnify an image, and the like. Performing the above functions with a printing device, which generally has less processor capabilities and/or memory size in comparison to a workstation, is generally slower than performing those functions on a workstation.

### SUMMARY OF THE INVENTION

Embodiment of the invention provide a printing device comprising a processor, a memory, a printing mechanism, means for interfacing with a workstation and with a image capturing device; and a communications bus in communication with the processor, printing mechanism, memory and the interface means. The printing device can be configured to communicate with a workstation and an image capturing device, to obtain an image from the image capturing device, to determine if the workstation is available to the printing device, and, if the workstation is available to the printing device, to automatically transmit the image and processing instructions to the workstation for processing, receive a processed image from the workstation, and print the processed image. The printing device can be further configured to process the image to generate a processed image and print the processed image, if the workstation is not available to the printing device.

Additional embodiments provide a method of printing an image captured by an image capturing device with a printing device. The method can include transmitting the image from the image capturing device to the printing device, determining if a workstation is connected to the printing device, and, if the workstation is connected to the printing device, automatically transmitting the image and processing instructions to the workstation for processing, processing the image at the workstation to generate a first processed image, transmitting the first processed image from the workstation to the printing device, and printing the first processed image at the printing device. The method can further include processing the image with the printing device to generate a second processed image, if the workstation is not connected to the printing device.

Another embodiment provides a computer-readable medium including instructions for printing an image captured by an image capturing device with a printing device. The computer-readable medium can include instructions for transmitting the image from the image capturing device to the printing device, determining if a workstation is connected to the printing device, and, if the workstation is connected to the printing device, automatically transmitting the image and processing instructions to the workstation for processing, processing the image by the workstation to generate a first processed image, transmitting the first processed image from the workstation to the printing device, and printing the first processed image at the printing device. The computer-readable medium can further include instructions for processing the image by the printing device to generate a second processed image, if the workstation is not connected to the printing device.

Yet another embodiment provides a driver operated by a workstation. The driver can be configured to obtain a device-specific image and processing instruction from a printing device when the printing device is connected to the workstation, to generate a generic image from the device-specific image, to obtain a processed image based on the generic image, and to generate a device-specific processed image based on the processed image, and to transmit the device-specific image to the printing device.

Other features and advantages of embodiments of the invention will become apparent to those skilled in the art upon review of the following detailed description and drawings.

### BRIEF DESCRIPTION OF THE DRAWINGS

In the drawings:

FIG. 1 illustrates an exemplary image processing system including a workstation, a printing device, and an image capturing device.

FIG. 2 is a schematic diagram of exemplary hardware inside the workstation, the printing device, and the image capturing device of FIG. 1.

FIG. 3 is a diagram of non-volatile memory, which can be part of the memory of the workstation illustrated in FIG. 3, illustrating that a portion of the non-volatile memory can be used to store a printing device driver.

FIG. 4 is a flow chart illustrating a process of printing an image recorded by an image capturing device.

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

### DETAILED DESCRIPTION

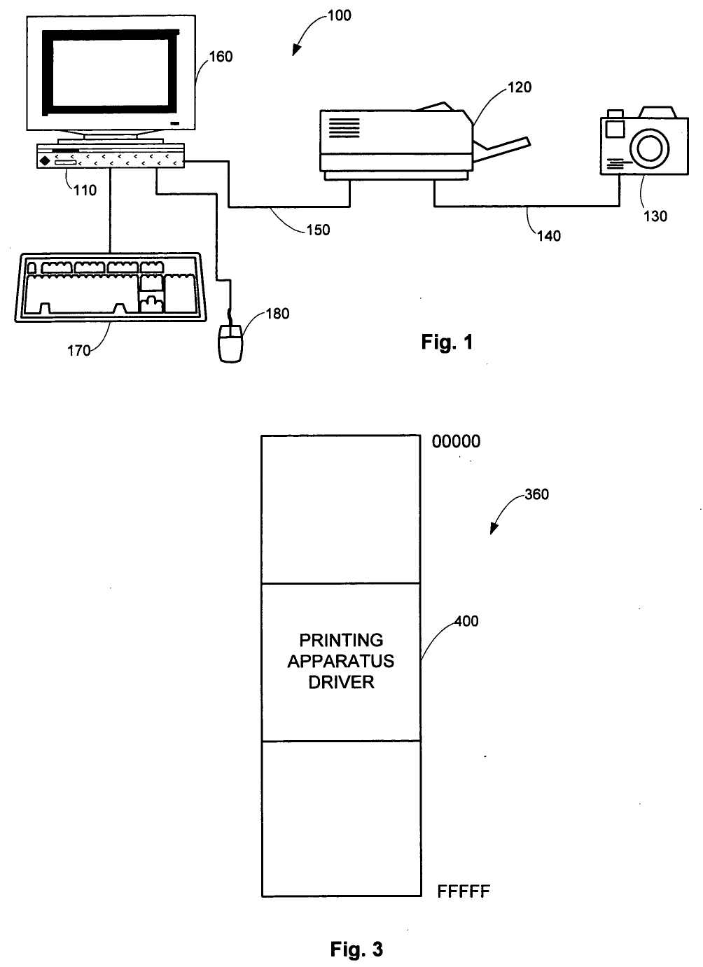

FIG. 1 illustrates an exemplary image processing system 100. The system 100 includes a workstation 110, a printing device 120, and an image capturing device 130. The printing device 120 and the image capturing device 130 can be connected by a connection 140. The connection 140 can include a wired connection and/or a wireless connection as well as local area network (“LAN”) connections and wide area network (“WAN”) connections. In some embodiments, the connection 140 includes a universal serial bus (“USB”) cable.

The image capturing device 130 can be configured to electronically record images. In some embodiments, the image capturing device 130 includes a digital camera and/or a scanner. The image capturing device 130 can also include a removable memory device connectable with a digital camera and/or scanner. The digital camera and/or scanner can electronically record or capture images and store them in the removable memory device or card. After recording images to the removable memory device, the removable memory device can be removed from the digital camera and/or scanner and can be connected to the printing device 120 via a suitable card reading device as is known. The image capturing device 130 can be constructed from multiple components. For example, the device 130 could include a digital camera docking station. The docking station can be configured to connect to the printing device 120.

The image capturing device 130 can transmit images to the printing device 120 over the connection 140. The printing device 120 can be configured to print a hardcopy of the image. In some embodiments, in addition to providing printing functionality, the printing device 120 can also be configured to provide scanning functionality, faxing functionality, copying functionality, or a combination thereof. The printing device 120 can be configured to print a hardcopy of data transmitted from the workstation 110 over a connection 150. The printing device 120 can also be configured to transmit electronic images to the workstation 110 over the connection 150 or another connection (not shown).

The workstation 110 can include a monitor 160, a keyboard 170, and a cursor control device 180, which is shown in the form of a mouse. The workstation 110 can also include additional peripherals. It should be understood that the monitor 160, the keyboard 170, the cursor control device 180, and any additional peripherals are optional.

As previously described, the workstation 110 can transmit data to be printed, faxed, copied, and the like, to the printing device 120 over the connection 150. The workstation 110 can also receive data transmitted from the printing device 120. In some embodiments, the printing device 120 can provide scanning functionality and can transmit electronic images to the workstation 110. The printing device 120 can also obtain an electronic image from the image capturing device 130 and can transmit the electronic image to the workstation 110 over the connection 150. In some embodiments, the printing device 120 can also transmit processing instructions associated with one or more electronic images to the workstation 110 over the connection 150. It should be understood, however, that the connection 150 is optional and the printing device 120 can operate as a stand-alone device. For example, the printing device 120 can be directly connected to the image capturing device 130 and can print electronic images recorded by the image capturing device 130 without requiring interaction with the workstation 110. As described above for the connection 140, the connection 150 can include a wired connection and/or a wireless connection as well as local area network (“LAN”) connections and wide area network (“WAN”) connections. In some embodiments, the connection 150 includes a universal serial bus (“USB”) cable.

As should also be apparent, the system 100 can include multiple workstations, printing devices, image capturing devices, and other devices not shown. In some embodiments, the system 100 can include routers, switches, or network connections that allow printing device 120 and other components to communicate with one or more workstations 110 and/or one or more image capturing devices.

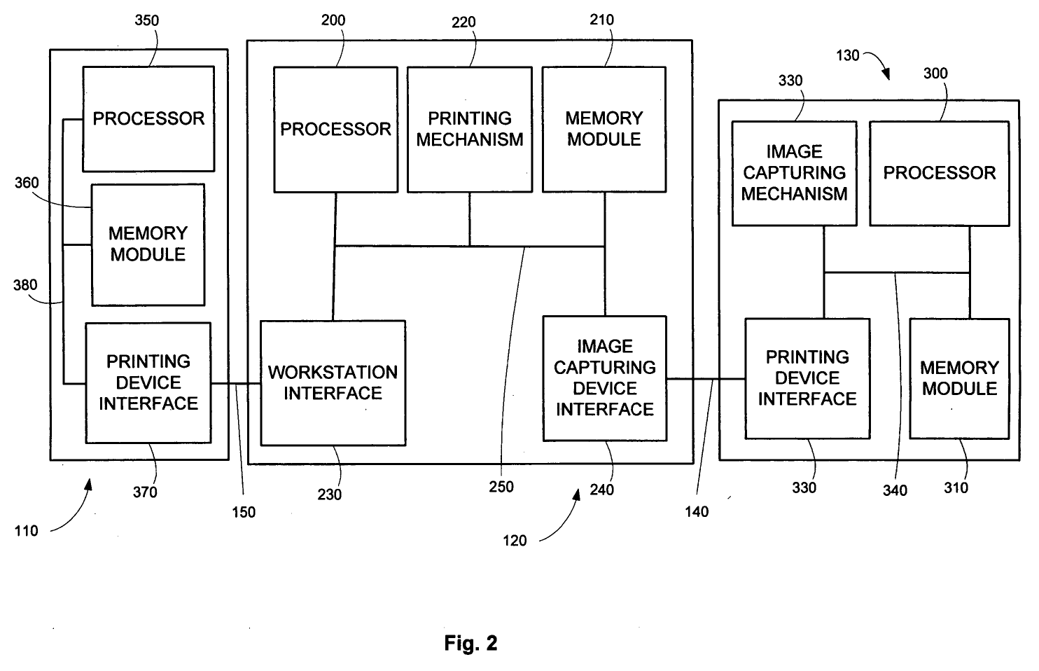

FIG. 2 illustrates exemplary hardware that can be included in the workstation 110, the printing device 120, and the image capturing device 130. As illustrated in FIG. 2, the printing device 120 includes a processor 200, a memory module 210, a printing mechanism 220, a workstation interface 230, and an image capturing device interface 240. The processor 200, the memory module 210, the printing mechanism 220, the workstation interface 230, and the image capturing device interface 240 can be connected by a bus 250.

The processor 200 of the printing device 120 (as well as the other processors 300 and 350 (described below)) can include a microprocessor, a macroprocessor, an application specific integrated circuit (“ASIC”), or a combination thereof. In some embodiments, the processor 200 can be configured to fetch instructions and/or data from the memory module 210 via the bus 250 and execute the instructions to process the data. The memory module 210 can include non-volatile memory such as one or more forms of ROM, one or more disk drives, RAM, other memory, or combinations of the foregoing.

The processor 200 can be configured to process images transmitted from the image capturing device interface 240 according to processing instructions. Processing instructions can include instructions for printing one or more images. The processor 200 can also be configured to operate the printing mechanism 220. The printing mechanism 220 can include a printhead and one or more print media rollers configured to move print media past the printhead. In some embodiments, the processor 200 transmits commands and data to the printing mechanism 220 via the bus 250. The commands can cause the printing mechanism 220 to print electronic data onto print media. Hardware and software techniques for generating a hardcopy of data are well-known in the art and, therefore, not described in detail.

Processing instructions transmitted from the image capturing device 130 can also include instructions for modifying one or more images before printing the images. For example, the processing instructions can include instructions for rotating an image, cropping an image, magnifying an image, generating a print index of one or more images, and the like. The processor 200 can be configured to modify one or more images as instructed by the processing instructions.

The workstation interface 230 can obtain data and/or processing instructions transmitted from the workstation 110. In some embodiments, the workstation 110 transmits data and/or processing instructions to workstation interface 230 of the printing device 120 over the connection 150. The processing instructions can instruct the printing device 120 to generate a hardcopy of the data transmitted from the workstation 110. The workstation interface 230 can also transmit data and/or processing instructions over the connection 150 to the workstation 110. As previously described, in some embodiments, the printing device 120 can use the workstation interface 230 to transmit electronic images to the workstation 110.

The image capturing device interface 240 can obtain images and/or processing instructions transmitted from the image capturing device 130. In some embodiments, the image capturing device interface 240 transmits images and/or processing instructions to the memory module 210 of the printing device 120 for temporary storage or buffering before printing. The image capturing device interface 240 can also transmit images and/or processing instructions to the processor 200. The image capturing device interface 240 can also transmit data to the image capturing device 130 over the connection 140. In some embodiments, the image capturing device interface 240 can also be configured to transmit status information (e.g., the success or failure of processing an image, a number of copies of an image printed, and the like) to the image capturing device 130.

The image capturing device 130 can include a processor 300, a memory module 310, an image capturing mechanism 320, and a printing device interface 330. The processor 300, the memory module 310, the image capturing mechanism 320, and the printing device interface 330 can be connected by a bus 340.

In some embodiments, the processor 300 can be configured to fetch instructions and/or data from the memory module 310 via the bus 340 and execute the instructions to process the data. The memory module 310 can include non-volatile memory such as one or more forms of ROM, one or more disk drives, RAM, other memory, or combinations of the foregoing. The memory module 310 can store electronic images. In some embodiments, the memory module 310 can be removed from the image capturing device 130.

The processor 300 can be configured to process electrical signals generated by the image capturing mechanism 320. The image capturing mechanism 320 can include an optical reduction sensor using one or more lenses and configured to convert light into electrical signals. The one or more lenses can be used to focus light on to the sensor. In some embodiments, the sensor includes a charged coupled device (“CCD”). The sensor can also include complementary metal oxide semiconductor (“CMOS”) sensor. The sensor can include light-sensitive diodes, called photosites, that convert photons (i.e., light rays) into electrons (i.e., electrical charges). The photosites can be configured such that the brighter the light rays applied to the photosites the greater the corresponding electrical charge. Contact image sensors (CIS) can also be used in the image capturing mechanism.

The processor 300 can obtain the electrical signals generated by the photosites and can convert the signals into digital values that specify the pixels of an electronic image. Digital values for the signals generated by the photosites, when taken together, can create an electronic image. The processor 300 can store electronic images to the memory module 310.

The printing device interface 330 can transmit electronic images to the printing device 120. The printing device interface 330 can be connected to the image capturing device interface 240 of the printing device 120. The printing device interface 330 can be connected to the image capturing device interface 240 by the connection 140. As previously described, the printing device interface 330 can also transmit processing instructions to the printing device 120. In some embodiments, the printing device interface 330 can also receive data from the printing device 120. The printing device 120 can transmit status information to the image capturing device 130 that is received by the printing device interface 330.

The workstation 110 can include a processor 350, a memory module 360, and a printing device interface 370. The processor 350, the memory module 360, and the printing device interface 370 can be connected by a bus 380.

In some embodiments, the processor 350 can be configured to fetch instructions and/or data from the memory module 360 via the bus 380 and execute the instructions to process the data. The memory module 360 can include non-volatile memory such as one or more forms of ROM, one or more disk drives, RAM, other memory, or combinations of the foregoing. The memory module 360 can store a printing device driver as will be described below.

The printing device interface 370 of the workstation 110 can transmit data to the printing device 120. The printing device interface 370 of the workstation 110 can be connected to the workstation interface 230 of the printing device 120 via the connection 150. As previously described, the printing device interface 370 of the workstation 110 can also receive electronic images and/or processing instructions from the printing device 120.

FIG. 3 represents a diagram of a portion of the memory module 360. As illustrated in FIG. 3, the memory module 360 can store a printing device driver 400. The printing device driver 400 can include a program that controls the printing device 120. The printing device driver 400 can act as a translator between the printing device 120 and programs executed by the workstation 110 that use the printing device 120. For example, the printing device 120 can have a set of commands that it responds to commands received from workstation 110. The printing device driver 400 can take generic commands to use the printing device 120 generated by programs executing on the workstation 110 and can translate the generic commands into commands that the printing device 120 accepts and can respond to.

The printing device driver 400 can also operate in the opposite direction. In some embodiments, the printing device driver 400 can take commands and/or data transmitted from the printing device 120 and can translate the commands and/or data into a format that the workstation 110, or a program executing on the workstation 110, accepts. For example, in some embodiments, the printing device driver 400 receives an electronic image from the printing device 120 and translates the electronic image into a generic image format (e.g., a device independent bitmap (“DIB”)). With the electronic image in a generic image format, the workstation 110 can process and modify the image. Once the image is processed, the workstation 110 can use the printing device driver 400 to convert the processed generic image into a processed device-specific image. The workstation 110 can also use the printing device driver 400 to transmit the process device-specific image back to the printing device 120.

The printing device driver 400 can be configured to comply with USB communication protocols. For example, the printing device driver 400 can include a human interface device (“HID”) class driver. The HID class driver can specify a protocol for exchanging data between the workstation 110 and the printing device 120. As specified by well-known USB communication protocols, when the printing device 120 is connected to the workstation 110 by the connection 150, the workstation 110 executes an enumeration process to configure the printing device 120. In some embodiments, the workstation 110 requests data structures or descriptors from the printing device 120. The data descriptors can include information specifying a number and type of communication channels (i.e., endpoints) for the printing device 120. For example, the printing device 120 can include a print channel for receiving print jobs and commands from the workstation 110 and a scan channel for transmitting scan jobs or images to the workstation 110. The data descriptors can also include information classifying the printing device 120 as belonging to a standard HID class. For example, the printing device 120 can belong to a display HID class. The display HID class can define basic functionality for display devices, such as monitors and printers.

The data descriptors can also include HID report descriptors. HID report descriptors can describe how the workstation 110 and the printing device 120 can interact. In particular, the HID report descriptors can describe a format of HID reports or messages that can be transmitted between the printing device 120 and the workstation 110. For example, the printing device 120 can transmit a HID report to the workstation 110 that specifies that the printing device 120 has obtained an electronic image from the image capturing device 130. The workstation 110 can return a HID report to the printing device 120 that requests the electronic image over a specific channel. The printing device 120 can then transmit the image in a HID report to the workstation 110 over the channel specified.

In some embodiments, after retrieving the data descriptors from the printing device 120, the workstation 110 assigns an address to the printing device 120 such that communications can be routed to the printing device 120. In some embodiments, once the printing device 120 is configured, the printing device driver 400 handles further communication with the printing device 120. The printing device driver 400 can include a HID class driver corresponding to a HID class specified by the data descriptors of the printing device 120.

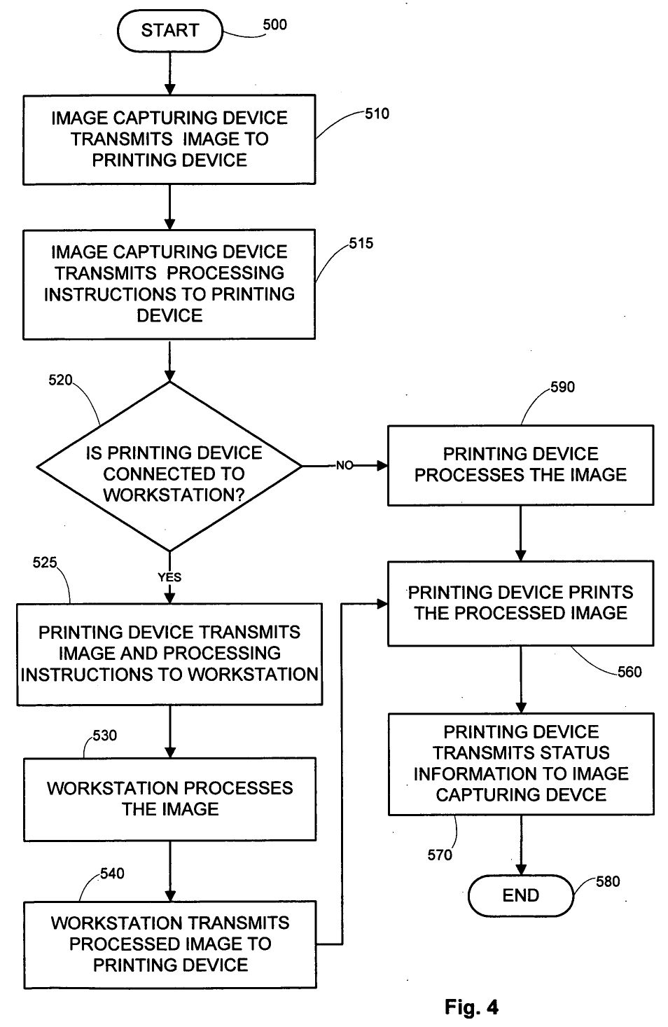

FIG. 4 illustrates an exemplary image processing method. In some embodiments, the image processing method illustrated in FIG. 4 is executed by the image processing system 100. It should be understood that the process steps illustrated in FIG. 4 are exemplary in order and content, and the image processing method can be accomplished with a subset of the depicted steps or additional and alternative steps.

As illustrated in FIG. 4, the process begins at start block 500. At block 510, the image capturing device 130 transmits an electronic image to the printing device 120. As previously defined, the image capturing device 130 can use a standard protocol for transmitting the image, such as the PictBridge® protocol. In some embodiments, the image capturing device 130 can also transmit processing instructions to the printing device 120 (block 515). As previously described, the processing instructions can include instructions for printing a single image, printing multiple images, printing multiple copies of one or more images, printing a print index of one or more images, and printing an image at a particular output size. The processing instructions can also include instructions for modifying an image. Modifying an image can include rotating an image, cropping an image, magnifying an image, and adding an effect to an image (e.g., adding a time and/or date stamp to an image, converting a color image to a black-and-white image, converting a black-and-white image to a color image, adding a sepia effect to an image, eliminating red-eye in an image, adding text or graphics to an image, etc.). As previously described, a user can use an operator panel of the image capturing device 130 to indicate processing instructions to be transmitted to the printing device 120. It should be understood that a user can use an operator panel of the printing device 120 to specify processing instructions in place of or in addition to processing instructions transmitted by the image capturing device 130. The printing device 120 can also be programmed with default processing instructions.

At block 520, the printing device 120 determines if it is connected to the workstation 110. In some embodiments, the printing device 120 can transmit a query or a ping over the connection 150. If the workstation 110 is attached to the printing device 120, the workstation 110 transits a message to the printing device 120 indicating reception of the query.

When the printing device 120 receives the return message from the workstation 110, the printing device 120 knows that it is connected to the workstation 110. The printing device 120 can then transmit the image and any processing instructions to the workstation 110 (block 525). In some embodiments, to begin transmission of the image and the processing instructions, the printing device 120 transmits a HID report to the workstation 110. The HID report indicates that the printing device 120 has obtained an electronic image from the image capturing device and wants to send the image to the workstation 110 for processing. In some embodiments, the workstation 110 transmits a HID report to the printing device 120 in return. The HID report transmitted by the workstation 110 can include instructions for transmitting the image and the processing instructions to the workstation 110. In some embodiments, the HID report transmitted by the workstation 110 can specify a channel or endpoint that the printing device 120 should use to transmit the image and the processing instructions. As previously described, in some embodiments, the printing device 120 can provide printing functionality and scanning functionality, and, during the enumeration process described above, the printing device 120 can specify one or more print channels configured to receive print jobs or commands from the workstation 110 and one or more scan channels configured to transmit electronic images to the workstation 110. The HID report transmitted by the workstation 110 can instruct the printing device 120 to transmit the image and the processing instructions over one of the scan channels. The HID report transmitted by the workstation 110 can also instruct the printing device 120 to transmit the image and the processing instructions over a print channel.

It should be understood that the processing instructions transmitted to the workstation 110 can include the processing instructions transmitted by the image capturing device 130 or a subset thereof. The processing instructions transmitted to the workstation 110 can also include additional processing instructions. In some embodiments, the workstation 110 can also be programmed with default processing instructions.

In some embodiments, the printing device 120 transmits portions or packets of the image and the processing instructions to the workstation 110. The printing device 120 can query the workstation 110 at predetermined intervals (e.g., after transmitting each packet, after transmitting a given number of packets, after transmitting data for a given amount of time, or the like) to ensure that the workstation 110 remains connected during transmission of the image and the processing instructions. If the workstation 110 fails to reply to a query at any point during the transmission, the printing device 120 can restart the connection determination process and/or the transmission process as described above. The printing device 120 can default to operating as a stand-alone device as described below.

After transmitting the image and the processing instructions to the workstation 110, the workstation 110 processes the image at block 530. In some embodiments, as described above, the printing device driver 400 converts the image transmitted from the printing device 120 into a generic image format before the workstation 110 processes the image according to the processing instructions. The printing device driver 400 can include instructions for processing the image according to the processing instructions. The workstation 110 can also include a separate program or application (e.g., a generic image editing or processing application) to process the image according to the processing instructions.

After the workstation 110 processes the image, the workstation 110 automatically transmits the processed image back to the printing device 120 (block 540). The workstation 110 can use the printing device driver 400 to convert the processed image into a specific print job or specific print commands accepted by the printing device 120. In some embodiments, the printing device driver 400 does not require specialized instructions for returning the processed image to the printing device 120. The printing device driver 400 can view the processed image as data directly initiated for printing by the workstation 110 rather than data originally initiated for printing by the image capturing device 130.

In some embodiments, if the printing device 120 retains a copy of the image and the processing instructions transmitted to the workstation 110. If the printing device 120 does not receive the processed image from the workstation 110 within a given amount of time, the printing device 120 can operate as a stand-alone device and can process the image as described below. Also, if the printing device 120 determines that the workstation 110 is not connected while the printing device 120 waits for the workstation 110 to return the processed image, the printing device 120 can operate as a stand-alone device. In some embodiments, the printing device 120 can be configured to connect to more than one workstation. If the printing device 120 does not receive the processed image from the workstation 110, the printing device 120 can transmit the image and processing instructions to another workstation.

Once the processed image is transmitted from the workstation 110 to the printing device 120, the printing device 120 prints the processed image (block 560). In some embodiments, after printing a hardcopy of the image, the printing device 120 transmits status information to the image capturing device 130 over the connection 140 (block 570). The status information can include whether the image was successfully printed, the number of copies of the image that were printed, what modifications were applied to the image, and the like. After transmitting status information to the image capturing device 130, the image processing process is complete (end block 580) and the process can begin again at start block 500 for another image transmitted by the image capturing device 130.

When the workstation 110 is not powered on or is not connected or is otherwise not available to the printing device 120, the workstation 110 does not receive the query sent by the printing device 120 and, therefore, does not send a return message to the printing device 120. In some embodiments, if the printing device 120 does not receive a return message from the workstation 110 within a given amount of time and/or after a given number of attempts, the printing device 120 can assume that it is not connected to the workstation 110. When the printing device 120 is not attached to the workstation 110, the printing device 120 operates as a stand-alone device and processes the image (block 590). As previously described, the processor 200 of the printing device 120 processes the image as instructed by the processing instructions.

After processing the image, the printing device 120 prints the processed image at block 560. The printing device 120 can then transmit status information to the image capturing device 130 at block 570 before ending the image processing process at end block 580.

In some embodiments, the processed image printed by the printing device 120 appears the same regardless if the image was processed by the workstation 110 or the printing device 120. The printed processed image can also be different depending on whether the workstation 110 processed the image or the printing device 120 processed the image. For example, some processing instructions can only be processed by the workstation 110 and not by the printing device 120. If the printing device 120 is not connected to the workstation 110, the printing device 120 cannot perform all the processing instructions, and the processed image printed by the printing device 120 may appear different depending on the availability of the workstation 110. In some embodiments, the printing device 120 can transmit status information to the image capturing device 130 that specifies whether the printing device 120 processed the image or the workstation 110 processed the image. The status information can also include any failures or errors (e.g., the processing instructions that could not applied by the printing device 120) that occurred during processing.

It should be understood that, in some embodiments, the processing performed by the workstation 110 does not require user interaction. For example, the image and processing instructions can be transmitted to the workstation 110 without the printing device 120 receiving an indication from a user to do so. The workstation 110 can also automatically process the image and return the processed image to the printing device 120 without requiring an indication from a user. In some embodiments, however, the printing device 120 can require an indication or selection from a user as to whether the image and processing instructions should be transmitted to the workstation 110. For example, the printing device 120 can inform a user, either on an operator panel of the printing device 120 or the image capturing device 130, that the printing device 120 is connected to the workstation 110. The user, using the operator panel, can decide whether to transmit the image and processing instructions to the workstation 110 or process the image internally by the printing device 120.

In some embodiments, the user can also use the operator panel to indicate whether the processed image should be automatically returned from the workstation 110 for printing. The user can use the operator panel to indicate that the workstation 110 should not return the processed image to the printing device 102 until receiving notification from a user to do so. In some embodiments, a user can use an image editing or processing program or application to further process the image before initiating transmission of the processed image to the printing device 120 for printing. A user can also view the processed image on the workstation 110 and can decide if she wants to print the processed image. If the user decides to print the processed image, the user can initiate transmission of the processed image to the printing device using the workstation 110.

Various features and advantages of the invention are set forth in the following claims.

1. A printing device comprising:
a processor;
a printing mechanism;
a memory;
means for interfacing with a workstation and with a image capturing device; and
a communications bus in communication with the processor, printing mechanism, memory and the interface means, wherein the processor is configured to:
communicate with the workstation and the image capturing device;
obtain an image from the image capturing device;
determine if the workstation is available to the printing device; and when the workstation is available to the printing device, automatically transmit the image and processing instructions to the workstation for processing, receive a processed image from the workstation, and print the processed image.

2. A printing device as claimed in claim 1, further configured to process the image to generate a processed image and print the processed image when the workstation is not available to the printing device.

3. A printing device as claimed in claim 1, further configured to obtain the processing instructions from the image capturing device.

4. A printing device as claimed in claim 1, further configured to obtain the processing instructions from user interaction with the printing device.

5. A printing device as claimed in claim 1, further configured to provide status information to the image capturing device.

6. A method of printing an image with a printing device, the image captured by an image capturing device, the method comprising:
transmitting the image from the image capturing device to the printing device;
determining if a workstation is available to the printing device; and
when the workstation is available to the printing device, automatically transmitting the image and processing instructions to the workstation, processing the image by the workstation to generate a first processed image, transmitting the first processed image from the workstation to the printing device, and printing the first processed image with the printing device.

7. A method as claimed in claim 6, further comprising processing the image with the printing device to generate a second processed image when the workstation is not available to the printing device.

8. A method as claimed in claim 7, further comprising printing the second processed image with the printing device when the workstation is not available to the printing device.

9. A method as claimed in claim 6, wherein transmitting the image from the image capturing device to the printing device includes transmitting the image without using the workstation.

10. A method as claimed in claim 6, further comprising transmitting the processing instructions from the image capturing device to the printing device.

11. A method as claimed in claim 6, further comprising obtaining the processing instructions from user interaction with the printing device.

12. A method as claimed in claim 6, further comprising transmitting status information from the printing device to the image capturing device.

13. A computer-readable medium including instructions for printing an image with a printing device, the image captured by an image capturing device, the instructions comprising:
transmitting the image from the image capturing device to the printing device;
determining if a workstation is available to the printing device; and
when the workstation is available to the printing device, automatically transmitting the image and processing instructions to the workstation, processing the image by the workstation to generate a first processed image, transmitting the first processed image from the workstation to the printing device, and printing the first processed image with the printing device.

14. A computer-readable medium as claimed in claim 13, further comprising instructions for processing the image by the printing device to generate a second processed image when the workstation is not connected to the printing device.

15. A computer-readable medium as claimed in claim 14, further comprising instructions for printing the second processed image with the printing device when the workstation is not connected to the printing device.

16. A computer-readable medium as claimed in claim 13, wherein instructions for transmitting the image from the image capturing device to the printing device include instructions for transmitting the image without using the workstation.

17. A computer-readable medium as claimed in claim 13, further comprising instructions for transmitting the processing instructions from the image capturing device to the printing device.

18. A computer-readable medium as claimed in claim 13, further comprising instructions for obtaining the processing instructions from user interaction with the printing device.

19. A computer-readable medium as claimed in claim 13, further comprising instructions for transmitting status information from the printing device to the image capturing device.

20. A driver operated by a workstation, the driver comprising instructions to:
obtain a device-specific image from a printing device when the printing device is connected to the workstation;
generate a generic image from the device-specific image;
obtain a processed image based on the generic image;
generate a device-specific processed image based on the processed image; and
transmit the device-specific image to the printing device.

21. A driver as claimed in claim 21, further configured to obtain processing instructions from the printing device when the printing device is connected to the workstation.

22. A driver as claimed in claim 21, wherein the processed image is further based on the processing instructions.
